(19) United States
(12) Patent Application Publication
(10) Pub. No.: US 2021/0374446 A1
(43) Pub. Date: Dec. 2, 2021

(54) SWITCH DEVICE

(71) Applicant: KABUSHIKI KAISHA TOKAI RIKA DENKI SEISAKUSHO, Aichi (JP)

(72) Inventors: Toshiaki IMAI, Aichi (JP); Naoki KAMIYA, Aichi (JP); Takashi UENO, Aichi (JP)

(73) Assignee: KABUSHIKI KAISHA TOKAI RIKA DENKI SEISAKUSHO, Aichi (JP)

(21) Appl. No.: 17/256,835

(22) PCT Filed: Jun. 25, 2019
(86) PCT No.: PCT/JP2019/025200

§ 371 Date: Dec. 29, 2020

(30) Foreign Application Priority Data
Jul. 2, 2018 (JP) 2018-125784

(51) Int. Cl. G06K 9/00; H01H 13/14

(52) U.S. Cl. CPC G06K 9/00919; G06K 9/0002; F02N 11/0803; G06K 2009/00932; H01H 13/14

(57) ABSTRACT

A switch device includes an operation button including an operation surface on which a push operation is performed, a guide recess portion that has an elongated shape surrounded by inclined surfaces and is provided on the operation surface to guide an operating finger, and a biometric information sensor including a reading surface for reading biometric information of the operating finger in contact therewith. The reading surface is exposed situated nearer an end surface of the guide recess portion in relation to a longitudinal center of the guide recess portion.

### CROSS-REFERENCES TO RELATED APPLICATIONS

The present patent application claims the priority of Japanese patent application No. 2018/125784 filed on Jul. 2, 2018, and the entire contents of Japanese patent application No. 2018/125784 are hereby incorporated by reference.

### TECHNICAL FIELD

The present invention relates to a switch device.

### BACKGROUND ART

A fingerprint sensor device is known in which a guide protrusion or recess is provided near a fingerprint sensor for reading a fingerprint and comes into contact with a finger when a user places his/her finger on the fingerprint sensor (see, e.g., Patent Literature 1).

The user remembers the position of the guide protrusion to the finger that the user felt during registration, and at the time of fingerprint authentication which is performed later, the user places his/her finger on the fingerprint sensor so as to feel the guide protrusion at the same position as during the registration, allowing the finger to be easily placed in the same position as during the registration. Therefore, the fingerprint sensor device can reduce an error in position of a fingerprint image at the time of authentication with respect to a pre-registered fingerprint image.

### CITATION LIST

### Patent Literature

Patent Literature 1: JP 2004/280360 A

### SUMMARY OF INVENTION

### Technical Problem

If the fingerprint sensor device of Patent Literature 1 is arranged on an operation button of a switch, a push operation is performed while finding the position of the guide protrusion or a push operation is performed in a state in which the guide protrusion is in contact with the finger. This is annoying or causes irritation to the finger, which may lead to a decrease in operability.

It is an object of the invention to provide a switch device with good operability.

### Solution to Problem

According to an embodiment of the invention, a switch device comprises:
an operation button comprising an operation surface on which a push operation is performed;
a guide recess portion that has an elongated shape surrounded by inclined surfaces and is provided on the operation surface to guide an operating finger; and
a biometric information sensor comprising a reading surface for reading biometric information of the operating finger in contact therewith,
wherein the reading surface is exposed situated nearer an end surface of the guide recess portion in relation to a longitudinal center of the guide recess portion.

### Advantageous Effects of Invention

According to an embodiment of the invention, it is possible to provide a switch device with good operability.

### BRIEF DESCRIPTION OF DRAWINGS

FIG. 1A is a front view showing a switch device in an embodiment.

FIG. 1B is a block diagram illustrating the switch device in the embodiment.

FIG. 2A is an explanatory front view showing a positional relation between a reading surface and a guide recess portion of the switch device in the embodiment.

FIG. 2B is a cross sectional view when a cross section cut along line II(b)-II(b) of FIG. 2A is viewed in a direction of arrows.

FIG. 2C is a cross sectional view when a cross section cut along line II(c)-II(c) of FIG. 2A is viewed in a direction of arrows.

FIG. 2D is a front view showing a guide recess portion of the switch device in modification.

FIG. 3A is a front view showing an operating finger.

FIG. 3B is a side view showing the operating finger.

FIG. 3C is an explanatory diagram illustrating a captured image which is captured by the switch device in the embodiment.

### DESCRIPTION OF EMBODIMENTS

(Short Summary of the Embodiment)

A switch device according to an embodiment has an operation button having an operation surface on which a push operation is performed, a guide recess portion that has an elongated shape surrounded by inclined surfaces and is provided on the operation surface to guide an operating finger, and a biometric information sensor having a reading surface for reading biometric information of the operating finger in contact therewith and is configured that the reading surface is exposed situated nearer an end surface of the guide recess portion in relation to a longitudinal center of the guide recess portion.

In this switch device, the reading surface is arranged nearer an end surface of the guide recess portion in relation to the longitudinal center of the guide recess portion. Therefore, as compared to when such a configuration is not adopted, it feels smooth to the finger, guiding performance is high and operability is good.

### Embodiment

(General Configuration of a Switch Device 1)

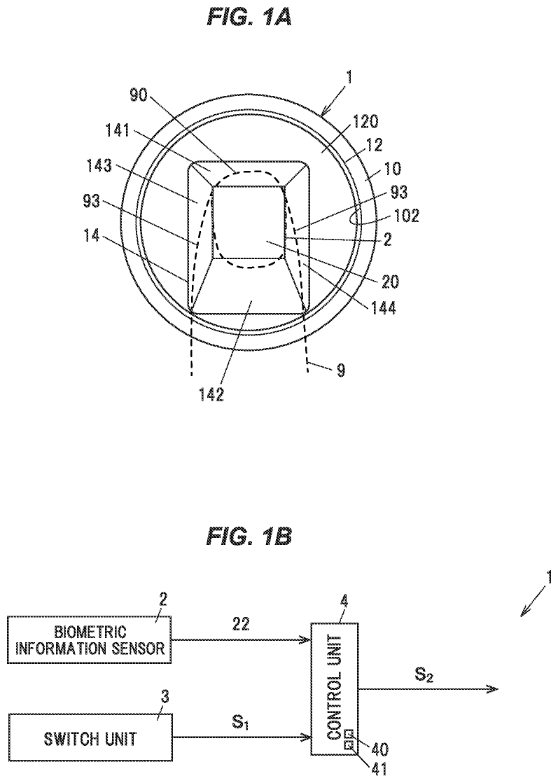

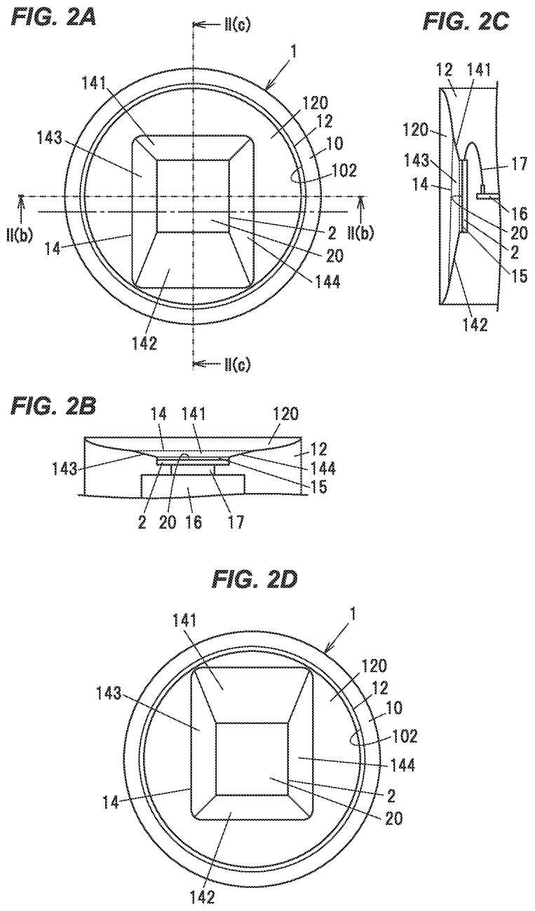

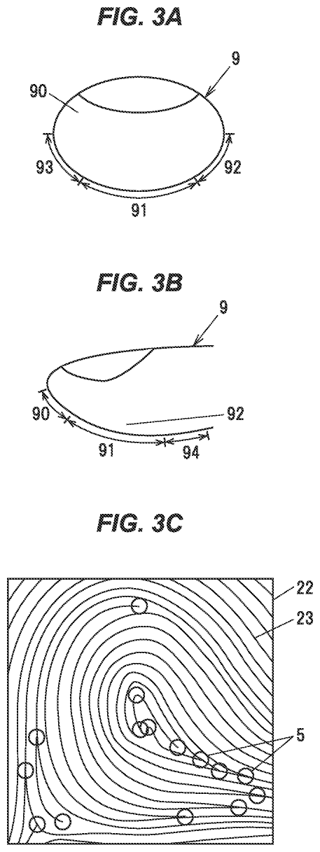

FIG. 1A is a front view showing a switch device in an embodiment and FIG. 1B is a block diagram illustrating the switch device in the embodiment. FIG. 2A is an explanatory front view showing a positional relation between a reading surface and a guide recess portion of the switch device in the embodiment, FIG. 2B is a cross sectional view when a cross section cut along line II(b)-II(b) of FIG. 2A is viewed in a direction of arrows, FIG. 2C is a cross sectional view when a cross section cut along line II(c)-II(c) of FIG. 2A is viewed in a direction of arrows and FIG. 2D is a front view showing a guide recess portion of the switch device in modification. FIG. 3A is a front view showing an operating finger, FIG. 3B is a side view showing the operating finger and FIG. 3C is an explanatory diagram illustrating a captured image which is captured by the switch device in the embodiment.

In each drawing of the embodiment described below, a scale ratio may be different from an actual ratio. In addition, in FIG. 1B, flows of main signal and information are indicated by arrows.

A switch device 1 is arranged on, e.g., a panel or a steering wheel in front of a user sitting in a driver's seat or on a floor console, etc., located between the driver's seat and the front passenger seat. When arranged on, e.g., a panel or a steering wheel in front of the user, a guide recess portion 14 in the present embodiment is positioned with a first inclined surface 141 on the upper side and a second inclined surface 142 on the lower side as shown in FIG. 1 in which the top and bottom on the paper coincide with the top and bottom of the vehicle. Meanwhile, when arranged on, e.g., a place substantially parallel to a floor of the vehicle such as a floor console, the guide recess portion 14 is positioned such that the second inclined surface 142 on the paper of FIG. 1A is located on the user side. In this regard, when, e.g., the guide recess portion 14 is positioned with respect to an operating finger 9 as shown in FIG. 1A, a reading surface 20 is not arranged on a third inclined surface 143 side or a fourth inclined surface 144 side since otherwise the guiding performance decreases.

The switch device 1 is configured to instruct a vehicle to start, or to prepare to start, a drive system of the vehicle upon successful authentication of biometric information 23 after a push operation (ON operation), and instruct to stop the drive system by a next push operation (OFF operation). The instruction to stop the drive system is given without authentication of the biometric information 23.

In particular, when the drive system is an internal combustion engine (an engine), the engine is started by a push operation performed in a state in which the operating conditions for a shifting device or a braking device are met. Meanwhile, when the drive system is a motor, preparation for start, which is a current supply to the motor, is carried out by a push operation performed in a state in which the above-described operating conditions are met. Furthermore, when the drive system is an engine/motor hybrid, start or preparation for start corresponding to the drive system prioritized at the time of start is carried out by a push operation performed in a state in which the above-described operating conditions are met. An OFF operation performed after this ON operation gives an instruction to stop the drive system.

The switch device 1 has, e.g., an operation button 12 having an operation surface 120 on which a push operation is performed, the guide recess portion 14 which has an elongated shape surrounded by inclined surfaces and is provided on the operation surface 120 to guide the operating finger 9, and a biometric information sensor 2 having the reading surface 20 for reading the biometric information 23 of the operating finger 9 in contact therewith and is configured that the reading surface 20 is exposed situated nearer an end surface (the first inclined surface 141 or the second inclined surface 142) in relation to a longitudinal center of the guide recess portion 14, as shown in FIGS. 1A and 1B.

The switch device 1 also has, e.g., a control unit 4 arranged on a substrate 16 and serving as an authentication unit which compares registered biometric information 40 pre-registered by a user to the biometric information 23 of the user read by the biometric information sensor 2 and authenticates whether or not the user is the registered person, as shown in FIGS. 1B, 2B and 2C.

The switch device 1 is further provided with, e.g., a cylindrical main body 10. The operation button 12 is inserted into an opening 102 of the main body 10. Furthermore, the switch device 1 is also provided with a switch unit 3 which detects that the operation button 12 is pushed toward the main body 10 by a push operation.

The substrate 16 mentioned above is, e.g., a printed circuit board. The control unit 4 is electrically connected to the biometric information sensor 2 via, e.g., a flexible substrate 17, as shown in FIGS. 2B and 2C. The substrate 16 is, e.g., attached to the operation button 12 and is configured to integrally move with the operation button 12 upon a push operation.

(Configuration of the Biometric Information Sensor 2)

The biometric information sensor 2 is a capacitive sensor, as an example. The biometric information sensor 2 is configured to read, e.g., the biometric information 23 from the operation finger 9 which is in contact with the reading surface 20 when the operation button 12 of the switch device 1 is operated, as shown in FIG. 1A.

The biometric information 23 is, e.g., a fingerprint of the operation finger 9 but it is not limited thereto, and it may be a vein of the operating finger 9.

As a modification, the biometric information sensor 2 may be, e.g., a sensor of pressure-sensitive type or thermal type, etc., which is configured to read a fingerprint. Alternatively, the biometric information sensor 2 may be configured to read, e.g., a vein of the operating finger 9 as the biometric information 23. The vein is read using, e.g., a sensor configured to read a vein pattern based on reflection of emitted infrared light. Alternatively, the biometric information sensor 2 may be, e.g., a sensor as a combination of these sensors.

A level difference portion 15 is provided between the reading surface 20 of the biometric information sensor 2 and the guide recess portion 14 as shown in, e.g., FIGS. 2B and 2C. The level difference portion 15 is provided to facilitate positioning of the operating finger 9, which has been guided by the guide recess portion 14, with respect to the reading surface 20 and contributes to performance of guiding the operating finger 9.

The biometric information sensor 2 is provided with, e.g., the plural detection electrodes which are arranged in rows and columns in a grid pattern under the reading surface 20. As an example, several ten thousand to several hundred thousand detection electrodes are formed and arranged at intervals of several μm to several tens μm.

The biometric information sensor 2 is configured to scan all detection electrodes by, e.g., repeating a process of reading capacitances of the detection electrodes arranged in one row while changing columns and then subsequently reading capacitances of the detection electrodes arranged in a different row. The scanning cycle is about 100 ms, as an example.

The biometric information sensor 2 outputs, e.g., a captured image 22, which is formed based on plural capacitances read by scanning, to the control unit 4. The captured image 22 is formed based on, e.g., capacitances in one cycle.

In particular, the biometric information sensor 2 generates the captured image 22 by, e.g., classifying the capacitances into capacitances of not less than a predetermined threshold value to be assigned “1” and capacitances of less than the threshold value to be assigned “0” and associating the capacitances with the positions of the detection electrodes.

The captured image 22 shown in FIG. 3C is produced in such a manner that the positions of the detection electrodes assigned “1” described above are shown in black and the positions of the detection electrodes assigned “0” are shown in white, as an example. The circles in the drawing are added to show some of characteristic features 5 (described later).

The high-capacitance positions are positions of ridges of the fingerprint which are close to the detection electrodes, hence, capacitance is high. Meanwhile, the low-capacitance positions are positions of valleys of the fingerprint which are far from the detection electrodes, hence, capacitance is low. Therefore, as an example, the captured image 22 shown in FIG. 3C is obtained when the high-capacitance positions are shown in black and the low-capacitance positions are shown in white. The image shown in black in the captured image 22 is the read biometric information 23.

The biometric information 23 is preferably, e.g., a fingerprint of a pulp region 91 of the operating finger 9 shown in FIGS. 3A and 3B. It is because the pulp region 91 includes many characteristic features 5 such as, e.g., center point (described later) shown in FIG. 3C. Therefore, the guide recess portion 14 and the level difference portion 15 guide so that the pulp region 91 comes into contact with the reading surface 20 even when the user performs a push operation without intentionally looking at the operation button 12.

(Configuration of the Switch Unit 3)

The switch unit 3 is configured as, e.g., a rubber dome switch which comes into contact with an end portion of the operation button 12 on the opposite side to the operation surface 120. The rubber dome switch is provided with, e.g., a rubber dome which generates an elastic force and has a movable contact, and a switch substrate on which the rubber dome is arranged and which has a fixed contact facing the movable contact.

When the operation button 12 is pushed into the main body 10 by a push operation, the movable contact is electrically conducted to the fixed contact due to deformation of the rubber dome and a switch signal S₁, which indicates that the switch is turned on, is output to the control unit 4. The switch device 1 is configured that when, e.g., the push operation ends, the operation button 12 returns to the initial position by an elastic force of the rubber dome.

(Configuration of the Control Unit 4)

The control unit 4 is, e.g., a microcomputer composed of a CPU (Central Processing Unit) performing calculation and processing, etc., of the acquired data according to a stored program, and a RAM (Random Access Memory) and a ROM (Read Only Memory) as semiconductor memories, etc. The ROM stores, e.g., a program for operation of the control unit 4. The RAM is used as, e.g., a storage area for storing the registered biometric information 40 and a similarity threshold 41 and also holding the acquired registered biometric information 40 and calculation results, etc. The control unit 4 stores, e.g., the registered biometric information 40 of each user and also the registered biometric information 40 that the user registered plural operating fingers.

The control unit 4 performs, e.g., an extraction process on the captured image 22 and extracts the characteristic features 5. The extraction process is, e.g., a process of extracting fingerprint ridges, etc.

The characteristic feature 5 is, e.g., a center point, a bifurcation point, an ending point or a delta, etc., as shown in FIG. 3C, but it is not limited thereto. The center point is a point at the center of the fingerprint. The bifurcation point is a point at which a fingerprint ridge bifurcates. The ending point is a point at which a ridge ends. The delta is a point at which ridges from three directions meet.

The control unit 4 extracts, e.g., the characteristic features 5 from the captured image 22. The control unit 4 then compares, e.g., the acquired registered biometric information 40 to the biometric information 23 from which the characteristic features 5 are extracted, and calculates similarity based on the positions of the characteristic features 5 and distances between the characteristic features 5, etc. Then, when the similarity is not less than the similarity threshold value 41, the control unit 4 outputs authentication information S₂ upon determination that the biometric information 23 is successfully authenticated.

The similarity threshold value 41 is 80%, as an example. In other words, when, e.g., the number of the characteristic features 5 of the biometric information 23 used for authentication is eighty and when not less than sixty-four characteristic features 5 match those of the registered biometric information 40, the control unit 4 determines that the user is a registered person. The match here includes match of the position of the characteristic feature 5 and a distance between the characteristic features 5, etc.

The control unit 4 determines, e.g., based on the switch signal S₁, that the switch unit 3 is turned on, i.e., a push operation is performed, and outputs the authentication information S₂, which indicates successful authentication, to an on-vehicle device electromagnetically connected thereto when the biometric information 23 is successfully authenticated. The on-vehicle device implements, e.g., a setting which has been set by a user who is successfully authenticated based on the authentication information S₂. The on-vehicle device when being, e.g., a seat driving device moves a seat to a seat position which has been set by the user. Meanwhile, the on-vehicle device when being, e.g., an air conditioner implements the settings, such as the set temperature and the air volume, which have been set by the user. Furthermore, the on-vehicle device when being, e.g., a mirror driving device drives mirrors to the positions which have been set by the user. Electromagnetic connection is, e.g., connection using at least one of connection via a conductor, connection via light which is a kind of electromagnetic wave, and connection via radio waves which is also a kind of electromagnetic wave.

(Configuration of the Guide Recess Portion 14)

The operation button 12 is configured that, e.g., the operation surface 120 has a concave shape as shown in FIG. 2A to 2C, but it is not limited thereto. Then, the reading surface 20 of the biometric information sensor 2 is arranged, e.g., at the center of the operation surface 120, as shown in FIG. 2A.

Dotted lines shown in FIG. 2A are straight lines which pass through the center of the circular operation surface 120 and are orthogonal to each other. Meanwhile, a dash-dot line shown in FIG. 2A is a straight line passing through the longitudinal center of the guide recess portion 14. The reading surface 20 is arranged so that its center is located on the first inclined surface 141 side relative to the dash-dot line and coincides with an intersection point of the dotted lines. In addition, the reading surface 20 is exposed on the bottom of the concave shape since the operation surface 120 has a concave shape.

The guide recess portion 14 has, as the inclined surfaces, e.g., the first inclined surface 141 and the second inclined surface 142, and the third inclined surface 143 and the fourth inclined surface 144, inclined from the operation surface 120 toward the reading surface 20 and facing each other via the reading surface 20, and is configured that the first inclined surface 141 or the second inclined surface 142 comes into contact with a tip region 90 of the operating finger 9, and the third inclined surface 143 and the fourth inclined surface 144 come into contact with two side regions (a left side region 92 and a left side region 93) of the operating finger 9, as shown in FIGS. 2A to 3B.

When, e.g., the operation surface 120 is a concave surface, the second inclined surface 142 of the guide recess portion 14 extends at a lower level than the operation surface 120. Therefore, the rim of the guide recess portion 14 is inclined with respect to the reading surface 20 as shown in FIG. 2C.

In case that the reading surface 20 is located on the first inclined surface 141 side, e.g., the tip region 90 of the operating finger 9 comes into contact with the first inclined surface 141 when the user performs a push operation, as shown in FIGS. 2A to 2C. Meanwhile, the left side region 92 of the operating finger 9 comes into contact with the third inclined surface 143 and the right side region 93 comes into contact with the fourth inclined surface 144. In addition, a pulp-rear-end region 94 of the operating finger 9 shown in FIG. 3B, which is located on the rear side of the pulp region 91, comes into contact with, e.g., the second inclined surface 142.

By such contact with the first inclined surface 141 to the fourth inclined surface 144, the operating finger 9 is guided and then the pulp region 91 fits to the level difference portion 15 and faces the reading surface 20. Here, if, e.g., the outer shape of the guide recess portion 14 is not an elongated shape but is close to a square, the operating finger 9 contacts in a narrow area in such a manner that the tip region 90 comes into contact with an inclined surface corresponding to the first inclined surface 141 and the pulp-rear-end region 94 with an inclined surface corresponding to the second inclined surface 142, which may cause unpleasant sensation due to irritation to the operating finger 9. However, since an inclination angle of the second inclined surface 142 in the present embodiment is smaller, i.e., more gradual than the other inclined surfaces, irritation to the operating finger 9 is small and unpleasant sensation is less likely to occur even when the pulp-rear-end region 94 contacts.

Meanwhile, if the level difference portion 15 is not formed, the second inclined surface 142 is less likely to serve as a stopper for stopping the operating finger 9 from slipping since the inclination angle of the second inclined surface 142 is small, which may result in misalignment between the pulp region 91 and the reading surface 20. However, since the level difference portion 15 is formed in the switch device 1 in the present embodiment, the pulp region 91 fits to the level difference portion 15 and it is thus easy for the user to find the position of the reading surface 20, and in addition to this, the level difference portion 15 suppresses slippage of the operating finger 9 and provides positioning of the pulp region 91 with respect to the reading surface 20.

Therefore, with the switch device 1, the pulp region 91 of the operating finger 9 of which biometric information 23 is to be read is easily positioned with respect to the reading surface 20 even when the user performs an operation without intentionally looking at the operation button 12, and unpleasant sensation to the operating finger 9 produced by contact with the guide recess portion 14 is also suppressed.

As a modification, the guide recess portion 14 may be provided so that the reading surface 20 is located on, e.g., the second inclined surface 142 side, as shown in FIG. 2D. In this case, since, e.g., the tip region 90 or the pulp region 91, etc., of the operating finger 9 comes into contact with the first inclined surface 141 having a small inclination angle when the user performs a push operation, it feels smooth to the finger. In addition, when, e.g., the operating finger 9 moves on the first inclined surface 141 as a result of performing a push operation, the level difference portion 15 and the second inclined surface 142 serve as a stopper and it is easy to position the pulp region 91 with respect to the reading surface 20, hence, high guiding performance.

### Effects of the Embodiment

The switch device 1 in the present embodiment is good in operability. In particular, in the switch device 1, the reading surface 20 is located on the first inclined surface 141 side of the guide recess portion 14 and this makes the inclination angle of the second inclined surface 142 more gradual than the other inclined surfaces. Therefore, it feels smooth to the finger, guiding performance is high and operability is good as compared to when the inclination angles are the same.

Since it is easy for the user to recognize the position of the reading surface 20 due to the presence of the level difference portion 15, the guiding performance of the switch device 1 is high as compared to when such a configuration is not adopted.

Since the guiding performance of the switch device 1 is high due to having the guide recess portion 14 and the level difference portion 15, it is possible to guide the operating finger 9 to an appropriate position even when the user is not intentionally looking at the operation button 12, as compare to when such a configuration is not adopted.

Since the switch device 1 guides the operating finger 9 to an appropriate position by the guide recess portion 14 and the level difference portion 15, the read biometric information 23 includes many characteristic features 5 usable for authentication and accuracy of authentication is improved, as compare to when such a configuration is not adopted.

In the switch device 1, the operation surface 120 has a concave shape. Therefore, ease of finding the position of the biometric information sensor 2 and guiding performance are higher than when not having a concave shape.

Although some embodiment and modifications of the invention have been described, these embodiment and modifications are merely examples and the invention according to claims is not to be limited thereto. These new embodiment and modifications may be implemented in various other forms, and various omissions, substitutions and changes, etc., can be made without departing from the gist of the invention. In addition, all combinations of the features described in these embodiment and modifications are not necessary to solve the problem of the invention. Further, these embodiment and modifications are included within the scope and gist of the invention and also within the invention described in the claims and the range of equivalency.

### REFERENCE SIGNS LIST

1 SWITCH DEVICE
2 BIOMETRIC INFORMATION SENSOR
9 OPERATING FINGER
12 OPERATION BUTTON
14 GUIDE RECESS PORTION
15 LEVEL DIFFERENCE PORTION
20 READING SURFACE
90 TIP REGION
91 PULP REGION
92 LEFT SIDE REGION
93 RIGHT SIDE REGION
94 PULP-REAR-END REGION
120 OPERATION SURFACE
141 FIRST INCLINED SURFACE
142 SECOND INCLINED SURFACE
143 THIRD INCLINED SURFACE
144 FOURTH INCLINED SURFACE

1. A switch device, comprising:
an operation button comprising an operation surface on which a push operation is performed;
a guide recess portion that has an elongated shape surrounded by inclined surfaces and is provided on the operation surface to guide an operating finger; and
a biometric information sensor comprising a reading surface for reading biometric information of the operating finger in contact therewith,
wherein the reading surface is exposed situated nearer an end surface of the guide recess portion in relation to a longitudinal center of the guide recess portion.

2. The switch device according to claim 1, wherein the operation button is configured that the operation surface has a concave shape.

3. The switch device according to claim 2, wherein the reading surface is arranged on a bottom of the concave shape of the operation surface.

4. The switch device according to claim 1, wherein the reading surface is arranged at the center of the operation surface.

5. The switch device according to claim 1, wherein the guide recess portion is configured that an opposite end surface to the end surface has a larger height from the reading surface than the end surface and a rim of the end surface is thus inclined with respect to the reading surface.

6. The switch device according to claim 1, wherein a level difference is provided between the reading surface and the guide recess portion.

7. The switch device according to claim 1, wherein the guide recess portion guides so that a pulp region of the operating finger faces the reading surface.

8. The switch device according to claim 1, wherein the guide recess portion comprises, as the inclined surfaces, a first inclined surface and a second, and a third inclined surface and a fourth inclined surface, inclined from the reading surface from the operation surface and facing each other via the reading surface, and is configured that the first inclined surface or the second inclined surface comes into contact with a tip region of the operating finger, and the third inclined surface and the fourth inclined surface come into contact with two side regions of the operating finger.

9. The switch device according to claim 8, wherein the reading surface is situated nearer the first inclined surface as the end face, and the second inclined surface has a smaller inclination angle than the other inclined surfaces.

10. The switch device according to claim 8, wherein the reading surface is situated nearer the second inclined surface as the end face, and the first inclined surface has a smaller inclination angle than the other inclined surfaces.
